(19) United States
(12) Patent Application Publication
(10) Pub. No.: US 2026/0079324 A1
(43) Pub. Date: Mar. 19, 2026

(54) REFLECTION MODULE AND CAMERA MODULE INCLUDING THE SAME

(71) Applicant: Samsung Electro-Mechanics Co., Ltd., Suwon-si (KR)

(72) Inventors: Nam Ju LEE, Suwon-si (KR); Young Bok YOON, Suwon-si (KR); Bo Sung SEO, Suwon-si (KR); Young Hwan KWON, Suwon-si (KR)

(73) Assignee: Samsung Electro-Mechanics Co., Ltd., Suwon-si (KR)

(21) Appl. No.: 19/284,183

(22) Filed: Jul. 29, 2025

(30) Foreign Application Priority Data
Sep. 19, 2024 (KR) 10-2024-0126524

(51) Int. Cl. G02B 7/182; G02B 27/64

(52) U.S. Cl. CPC G02B 7/1827; G02B 27/646

(57) ABSTRACT

A reflection module includes a housing having an internal space; a reflection member disposed in the internal space; a carrier rotatably disposed with the reflection member in the internal space; and a plurality of ball members disposed between the housing and the carrier to support rotation of the carrier. The carrier and the housing include a plurality of guide grooves disposed to face each other. one or more guide grooves, among the plurality of guide grooves, include two side surfaces having different slopes with respect to a plane perpendicular to a rotational axis of the carrier. The two side surfaces contact one ball member of the plurality of ball members accommodated in a corresponding one of the one or more guide grooves.

### CROSS-REFERENCE TO RELATED APPLICATIONS

This application claims the benefit under 35 USC 119(a) of Korean Patent Application No. 10-2024-0126524 filed on Sep. 19, 2024, in the Korean Intellectual Property Office, the entire disclosure of which is incorporated herein by reference for all purposes.

### BACKGROUND

### 1. Field

The following description relates to a camera module including a reflection module.

### 2. Description of the Background

Camera modules in mobile devices may be manufactured to have degrees of performance comparable to those of conventional cameras.

For example, a camera module provided in a mobile device may include a reflection member. Since the reflection member bends a path of light, the path of light may be sufficiently increased without increasing a thickness of the mobile device, thereby improving performance of the camera module.

In a camera module, a reflection member may be disposed to be rotatable in an optical image stabilization while being mounted on another component. For example, the camera module may be provided with a ball bearing to support the rotation of the reflection member. The ball bearing may act like a wheel, and may help movement of the reflection member with a relatively small force. However, in a conventional structure, since a ball bearing rolls with a high degree of freedom, there may be a problem that driving performance differs depending on the position of the ball bearing.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a reflection module includes a housing having an internal space; a reflection member disposed in the internal space; a carrier rotatably disposed with the reflection member in the internal space; and a plurality of ball members disposed between the housing and the carrier to support rotation of the carrier. The carrier and the housing include a plurality of guide grooves disposed to face each other. one or more guide grooves, among the plurality of guide grooves, include two side surfaces having different slopes with respect to a plane perpendicular to a rotational axis of the carrier. The two side surfaces contact one ball member of the plurality of ball members accommodated in a corresponding one of the one or more guide grooves.

The plurality of ball members may include a first guide ball and a second guide ball, each spaced apart from another and from the rotational axis of the carrier, and accommodated in the plurality of guide grooves. A number of contact points in which the first guide ball forms with a corresponding one of the plurality of guide grooves may be greater than a number of contact points in which the second guide ball forms with a corresponding one of the plurality of guide grooves.

The carrier may include a first guide groove accommodating a portion of the first guide ball, and a second guide groove accommodating a portion of the second guide ball. The housing may include a third guide groove accommodating another portion of the first guide ball, and a fourth guide groove accommodating another portion of the second guide ball. At least the third guide groove, among the first guide groove and the third guide groove, may include the two side surfaces.

A second side surface of the two side surfaces may be farther from the rotational axis of the carrier than a first side surface of the two side surfaces, and a slope of the second side surface may be less inclined than a slope of the first side surface.

The first guide groove may include a third side surface and a fourth side surface farther from the rotational axis of the carrier than the third side surface. A slope of the fourth side surface may be less inclined than a slope of the third side surface.

The first guide ball may be in contact with the first guide groove at one or two points.

The second guide ball may contact each of the second guide groove and the fourth guide groove at one point.

The plurality of guide grooves may extend in a rotational direction of the carrier.

A portion of the one or more guide grooves may include a reinforcing portion including a material having higher rigidity than other portions of the carrier and the housing.

The plurality of ball members may further include a rotation axis ball forming the rotation axis of the carrier and spaced apart from the first guide ball and the second guide ball.

A camera module may include the reflection module above; a first lens module, including one or more lenses disposed in a first optical axis direction, coupled to the reflection module; and a second lens module, including a plurality of lenses disposed in a second optical axis direction perpendicular to the first optical axis direction, movably disposed in the second optical axis direction.

In another general aspect, a reflection module includes a housing having an internal space; a reflection member disposed in the internal space; a carrier rotatably disposed with the reflection member in the internal space; and a first guide ball and a second guide ball, disposed between the housing and the carrier. Each of the carrier and the housing includes a first guide groove accommodating the first guide ball and a second guide groove accommodating the second guide ball. The first guide groove in the carrier and the first guide groove in the housing are asymmetrical with respect to the first guide ball. The second guide groove in the carrier and the second guide groove in the housing are symmetrical with respect to the second guide ball.

The first guide groove in the housing may include two side surfaces having different slopes with respect to a plane perpendicular to a rotational axis of the carrier, and the two side surfaces may contact the first guide ball.

The two side surfaces may include a first side surface and a second side surface farther from the rotational axis of the carrier than the first side surface. A contact radius of the first guide ball with respect to the second side surface may be greater than a contact radius of the first guide ball with respect to the first side surface.

The two side surfaces may include a first side surface and a second side surface farther from the rotational axis of the carrier than the first side surface. A slope of the second side surface may be less inclined than a slope of the first side surface.

The first guide groove in the carrier and the second guide groove in the carrier and the housing may include a bottom surface having a planar shape, and contacting the first guide ball or the second guide ball.

A camera module may include the reflection module above; a first lens module, including one or more lenses disposed in a first optical axis direction, coupled to the reflection module; and a second lens module, including a plurality of lenses disposed in a second optical axis direction perpendicular to the first optical axis direction, movably disposed in the second optical axis direction.

Other features and aspects will be apparent from the following detailed description, the drawings, and the claims.

### BRIEF DESCRIPTION OF DRAWINGS

FIG. 1 is a perspective view of a camera module according to an embodiment of the present disclosure.

FIG. 2 is an internal perspective view of a camera module according to an embodiment of the present disclosure.

FIG. 3 is a schematic exploded perspective view of a camera module according to an embodiment of the present disclosure.

FIG. 4 is a perspective view of an optical image stabilization unit according to an embodiment of the present disclosure.

FIG. 5 is an exploded perspective view of the optical image stabilization unit of FIG. 4.

FIG. 6 is an exploded perspective view of the optical image stabilization unit, viewed from a different angle from FIG. 5.

FIG. 7 is a cross-sectional view of FIG. 4, taken along line I-I′.

FIG. 8 is a cross-sectional view of FIG. 4, taken along line II-II′.

FIG. 9 is a cross-sectional view of FIG. 4, taken along line III-III′.

FIG. 10A is an enlarged view of portion A of FIG. 9, and FIG. 10B is an enlarged view of portion B of FIG. 9.

FIG. 11 is a perspective view of a rotary holder according to another embodiment of the present disclosure.

FIG. 12 is a cross-sectional view of FIG. 4, taken along line IV-IV′.

FIG. 13 is an enlarged view of portion A′ of FIG. 12.

FIG. 14 is an exploded perspective view of a focus adjustment unit according to an embodiment of the present disclosure.

FIG. 15 is an exploded perspective view of a focus adjustment unit, viewed from a different angle than FIG. 14.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

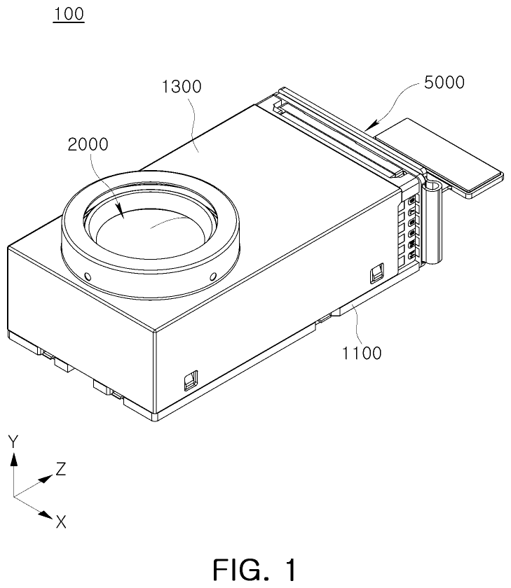

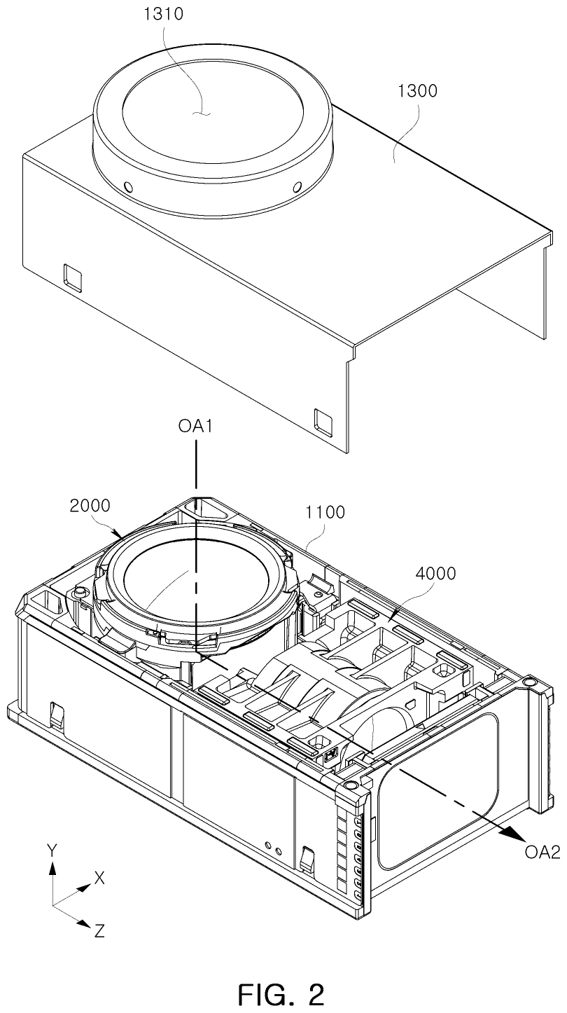

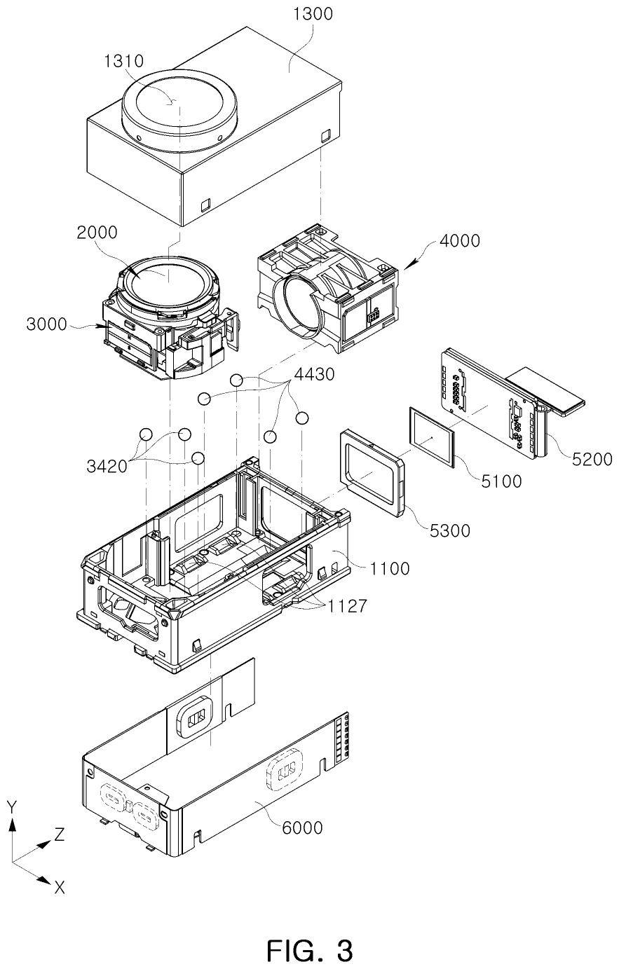

FIG. 1 is a perspective view of a camera module according to an embodiment of the present disclosure. FIG. 2 is an internal perspective view of a camera module according to an embodiment of the present disclosure. FIG. 3 is a schematic exploded perspective view of a camera module according to an embodiment of the present disclosure.

Referring to FIGS. 1 to 3, a camera module 100 according to an embodiment of the present disclosure may include a plurality of lens modules 2000 and 4000, a reflection module 3000, and an image sensor module 5000, and a housing 1100 and a case 1300, accommodating them.

The plurality of lens modules 2000 and 4000 may include a first lens module 2000 and a second lens module 4000 having different optical axes.

The first lens module 2000 and the second lens module 4000 may include one or more lenses disposed along respective optical axes thereof. In an embodiment, the optical axis of the first lens module 2000 (hereinafter, a first optical axis OA1) and the optical axis of the second lens module 4000 (hereinafter, a second optical axis OA2) may be approximately perpendicular to each other. For example, the first optical axis OA1 may be approximately parallel to a height direction (Y-axis direction) of the camera module 100, and the second optical axis OA2 may be approximately parallel to a length direction (Z-axis direction) of the camera module 100.

The reflection module 3000 may be disposed between the first lens module 2000 and the second lens module 4000.

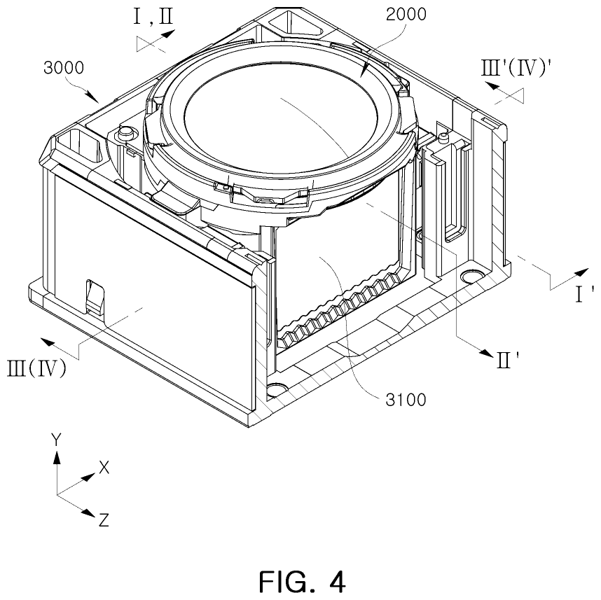

The reflection module 3000, e.g., seen in FIG. 4, may include a reflection member 3100 changing a direction of propagation of incident light. For example, the reflection member 3100 may change the direction of propagation of incident light from a direction of the first optical axis OA1 to a direction of the second optical axis OA2.

A reflective surface of the reflection member 3100 may be disposed obliquely with respect to the first optical axis OA1 and the second optical axis OA2. For example, an angle between the reflective surface and the first optical axis OA1, and an angle between the reflective surface and the second optical axis OA2 may be approximately 45 degrees.

Although not illustrated in the attached drawings, the camera module 100 may further include a reflection module disposed between the second lens module 4000 and the image sensor module 5000. In this case, the direction of propagation of incident light may be changed two or more times until the incident light reaches the image sensor module 5000.

The image sensor module 5000 may be disposed behind the second lens module 4000. For example, incident light may pass through the first lens module 2000, the reflection module 3000, and the second lens module 4000 in sequence, and may then finally be incident on the image sensor module 5000.

The image sensor module 5000 may include an image sensor 5100 converting incident light into an electric signal, and a printed circuit board (hereinafter, sensor board) 5200 on which the image sensor 5100 is mounted.

In addition, the image sensor module 5000 may include an optical filter 5300 disposed between the second lens module 4000 and the image sensor 5100 to filter light incident onto the image sensor 5100. For example, the optical filter 5300 may be an infrared blocking filter.

Alternatively, the image sensor module 5000 may include a light-blocking member (baffle) between the second lens module 4000 and the image sensor 5100 to block a portion of light incident on the image sensor 5100.

In an embodiment, the image sensor module 5000 may include one or more of the optical filter 5300 and the baffle.

The housing 1100 may have an internal space in which the plurality of lens modules 2000 and 4000 and the reflection module 3000 are accommodated.

In an embodiment, the internal space of the housing 1100 may accommodate both the plurality of lens modules 2000 and 4000 and the reflection module 3000. In another embodiment, the camera module 100 may include a plurality of housings, and the plurality of lens modules 2000 and 4000 and the reflection module 3000 may be accommodated in the plurality of housings.

The image sensor module 5000 may be disposed on an outer surface of the housing 1100. The image sensor 5100 may be exposed to the internal space of the housing 1100 through a through-hole formed on the outer surface of the housing 1100.

In addition, a printed circuit board (hereinafter, main board) 6000 on which a portion of a driving portion of the camera module 100 is mounted may be disposed on the outer surface of the housing 1100.

In an embodiment, the main board 6000 may be provided to be bent in a portion, and may be disposed across different surfaces of the housing 1100. For example, the main board 6000 may be disposed to cover several side surfaces and a portion of a bottom surface of the housing 1100.

The case 1300 may be coupled to the housing 1100 to cover an exposed upper portion of the housing 1100. In an embodiment, the case 1300 may include a metal material to function as a shield can.

The case 1300 may include an opening 1310 through which light passes. Light may be incident on the first lens module 2000 through the opening 1310.

A camera module 100 according to an embodiment of the present disclosure may basically have an optical image stabilization function (OIS) and an auto focus function (AF).

In an embodiment, to compensate for shaking, the reflection module 3000 may be provided to be rotatable about two axes. In addition, to adjust focus, the second lens module 4000 may be provided to be movable in a direction of the second optical axis OA2.

To this end, the reflection module 3000 and the second lens module 4000 may be disposed in the housing 1100 via a ball member. The movement of the reflection module 3000 and the movement of the second lens module 4000 may be relative movements with respect to the housing 1100.

In an embodiment, the reflection module 3000 may be accommodated in the housing 1100 while being coupled to the first lens module 2000. For example, the first lens module 2000 may be coupled to an upper end portion of the reflection module 3000, and thus may rotate together with the reflection module 3000 during optical image stabilization.

In another embodiment, the first lens module 2000 may be provided as a fixed member coupled to the housing 1100 or the case 1300, or may be provided to be drivable independently of the reflection module 3000.

A camera module 100 according to an embodiment of the present disclosure may also have a zoom function. The zoom function may be implemented by moving the second lens module 4000.

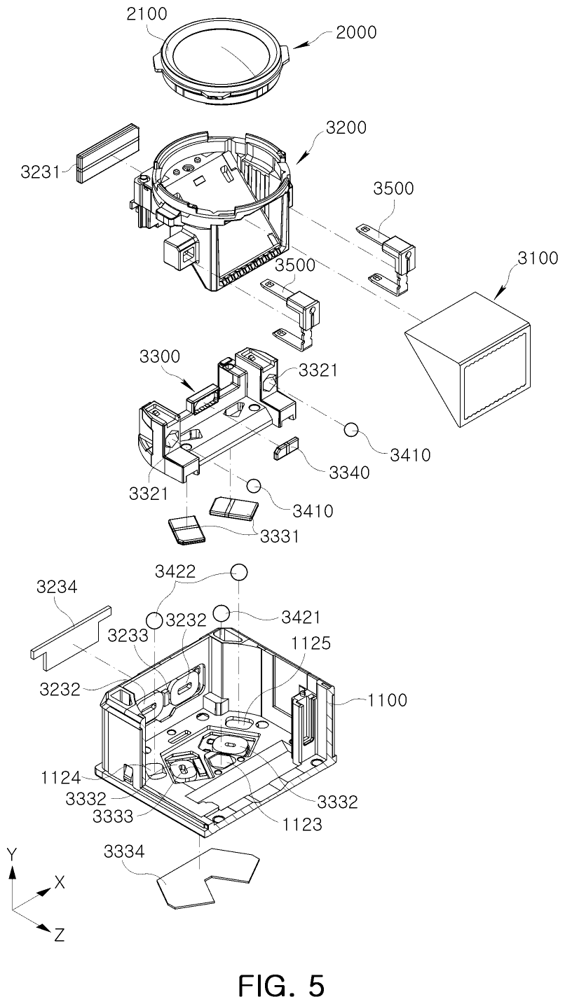

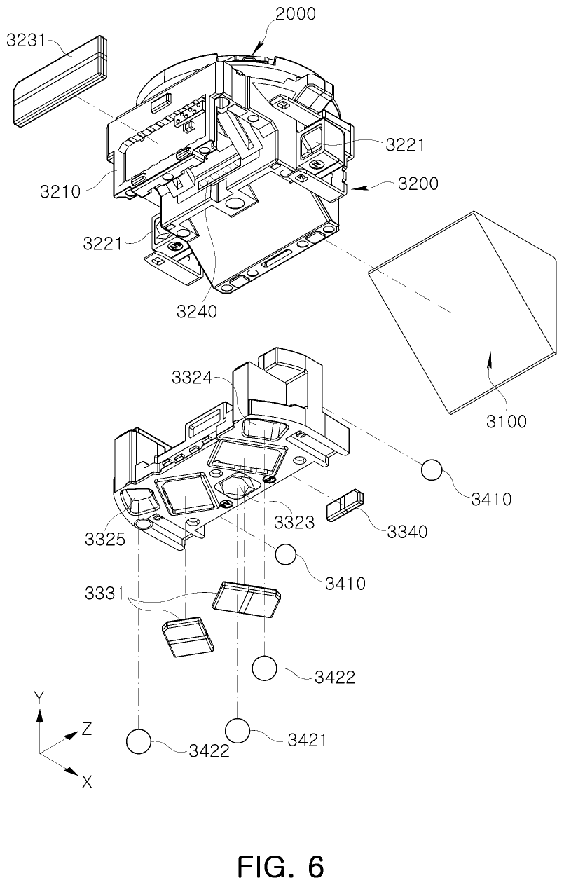

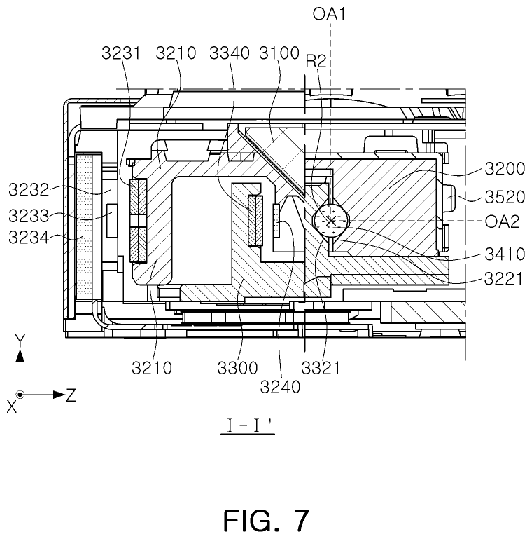

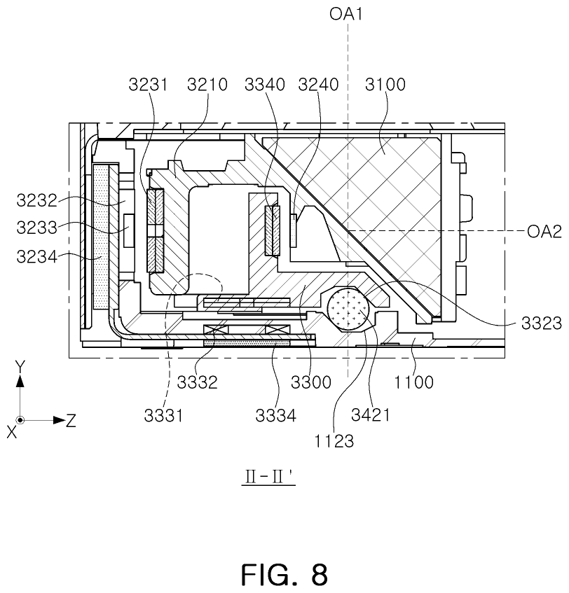

FIG. 4 is a perspective view of an optical image stabilization unit according to an embodiment of the present disclosure. FIG. 5 is an exploded perspective view of the optical image stabilization unit of FIG. 4. FIG. 6 is an exploded perspective view of the optical image stabilization unit, viewed from a different angle from FIG. 5. FIG. 7 is a cross-sectional view of FIG. 4, taken along line I-I′. FIG. 8 is a cross-sectional view of FIG. 4, taken along line II-II′.

Referring to FIG. 4, an optical image stabilization unit may include a first lens module 2000 and a reflection module 3000.

The first lens module 2000 and the reflection module 3000 may be disposed in a direction of a first optical axis OA1.

Referring to FIGS. 5 and 6, the first lens module 2000 may include a first lens barrel 2100 on which one or more lenses are mounted, and the reflection module 3000 may include a reflection holder 3200 on which a reflection member 3100 is mounted, and a carrier 3300 on which the reflection holder 3200 is supported.

In an embodiment, the first lens barrel 2100 may be disposed in the reflection holder 3200 together with the reflection member 3100. For example, the first lens barrel 2100 may be coupled to an upper end portion of the reflection holder 3200 to be spaced apart from an incident surface of the reflection member 3100 in the direction of the first optical axis OA1.

The carrier 3300 may be rotatably supported in a housing 1100 while rotatably supporting the reflection holder 3200.

In an embodiment, the reflection holder 3200 may rotate about a first rotation axis (hereinafter, a first axis) (X-axis) while being supported by the carrier 3300, and the carrier 3300 may rotate about a second rotation axis (hereinafter, a second axis) (Y-axis) together with the reflection holder 3200 while being supported by the housing 1100. The first axis (X-axis) and the second axis (Y-axis) may be perpendicular to each other.

The reflection member 3100 and the first lens module 2000, provided in the reflection holder 3200, may rotate together with the reflection holder 3200. Therefore, according to an embodiment of the present disclosure, the first lens barrel 2100 equipped with the one or more lenses and the reflection member 3100 may rotate about two axes, perpendicular to each other.

A first ball member 3410 supporting rotation of the reflection holder 3200 with respect to the carrier 3300 may be disposed between the reflection holder 3200 and the carrier 3300.

In an embodiment, the first ball member 3410 may include a plurality of ball members spaced apart in a direction of the first axis (X-axis) with the reflection member 3100 interposed therebetween. The first ball member 3410 may form the first axis (X-axis) while rotating in place in a fixed position relative to the reflection holder 3200 and the carrier 3300. The first axis (X-axis) may pass through the first ball member 3410.

The reflection holder 3200 and the carrier 3300 may include accommodation grooves 3221 and 3321 accommodating the first ball member 3410. Each of the accommodation grooves 3221 and 3321 may be provided spaced apart in the direction of the first axis (X-axis), and may be provided in a number corresponding to the number of first ball members 3410.

In an embodiment, the reflection holder 3200 may include a first accommodation groove 3221 accommodating a portion of the first ball member 3410, and the carrier 3300 may include a second accommodation groove 3321 provided to face the first accommodation groove 3221 and accommodating another portion of the first ball member 3410. For example, the first accommodation groove 3221 and the second accommodation groove 3321 may face each other in a direction of a second optical axis OA2 (or the third axis (Z-axis)).

The first ball member 3410 may be supported at three or two points by the first accommodation groove 3221 and the second accommodation groove 3321. For example, the first accommodation groove 3221 and the second accommodation groove 3321 may include three or two inclined surfaces.

In an embodiment, the first accommodation groove 3221 and the second accommodation groove 3321 may include three inclined surfaces to rotate the first ball member 3410 in place. In addition, the first accommodation groove 3221 or the second accommodation groove 3321 may include two inclined surfaces to overcome defects due to tolerance.

The reflection holder 3200 may be supported on the carrier 3300 by magnetic force (magnetic attraction). To this end, a first magnetic body 3240 may be disposed on the reflection holder 3200, and a second magnetic body 3340 may be disposed on the carrier 3300 to face the first magnetic body 3240. For example, one of the first magnetic body 3240 or the second magnetic body 3340 may be a pulling magnet, and the other thereamong may be a pulling yoke.

The first magnetic body 3240 and the second magnetic body 3340 may generate magnetic attraction in a direction facing each other. In an embodiment, the first magnetic body 3240 and the second magnetic body 3340 may face each other in a direction of the third-axis (Z-axis), and magnetic attraction therebetween may be generated in the direction of the third-axis (Z-axis). Therefore, the reflection holder 3200 may be supported on the carrier 3300 in the direction of the third-axis (Z-axis).

A direction in which the reflection holder 3200 is supported on the carrier 3300 may be consistent with a direction in which the reflection holder 3200 faces the carrier 3300 with the first ball member 3410 interposed therebetween. Therefore, the first ball member 3410 may stably support the rotation of the reflection holder 3200 without being separated from the reflection holder 3200 and the carrier 3300 by magnetic attraction generated between the first magnetic body 3240 and the second magnetic body 3340.

The reflection module 3000 may include a first driving unit providing a driving force for rotating the reflection holder 3200.

The first driving unit may include a first driving magnet 3231 and a first driving coil 3232, disposed to face each other. The reflection holder 3200 may rotate about the first axis (X-axis) by electromagnetic interaction between the first driving magnet 3231 and the first driving coil 3232.

In an embodiment, the first driving magnet 3231 may be disposed in the reflection holder 3200, and the first driving coil 3232 may be disposed in the housing 1100. However, a position of the first driving magnet 3231 and a position of the first driving coil 3232 may be swapped, or one thereof may be disposed in the reflection holder 3200 while the other thereof may be disposed in a different configuration.

The reflection holder 3200 may include an extension portion 3210 extending from the reflection holder 3200, and may be disposed between the carrier 3300 and the housing 1100, and the first driving magnet 3231 may be disposed in the extension portion 3210.

The first driving coil 3232 may be mounted on a main board 6000, and may be disposed in the housing 1100. The first driving coil 3232 may be exposed to an internal space of the housing 1100 through a through-hole formed in the housing 1100, and thus may directly face the first driving magnet 3231.

In an embodiment, the first driving magnet 3231 and the first driving coil 3232 may face each other in a direction, parallel to the third axis (Z-axis). The third axis (Z-axis) may be a direction, perpendicular to both the first axis (X-axis) and the second axis (Y-axis).

The first driving magnet 3231 may be magnetized in the direction of the second axis (Y-axis)—approximately a rotational direction of the reflector holder 3200. For example, one surface of the first driving magnet 3231 facing the first driving coil 3232 may include an N-pole (S-pole) area, a neutral area, and an S-pole (N-pole) area, in the direction of the second axis (Y axis).

The first driving unit may include a first yoke 3234 facing the first driving magnet 3231 with the first driving coil 3232 interposed therebetween.

The first yoke 3234 may be disposed on the other surface of the main board 6000—a surface opposite to a surface on which the first driving coil 3232 is disposed. The first yoke 3234 may be provided as a magnetic body, and may focus the magnetic flux of the first driving magnet 3231.

In addition, the first driving unit may include a first position sensor 3233 detecting a position of the first driving magnet 3231. For example, the first position sensor 3233 may be a Hall sensor, and may detect a change in magnetic flux to detect an amount of movement of the first driving magnet 3231.

The first position sensor 3233 may be located to face a neutral area of the first driving magnet 3231 when the reflection holder 3200 is in a neutral position.

The first position sensor 3233 may be located on one surface of the main board 6000 together with the first driving coil 3232, and may be located in an inner side or an outer side of the first driving coil 3232.

A second ball member 3420 supporting rotation of the carrier 3300 relative to the housing 1100 may be disposed between the carrier 3300 and the housing 1100.

In an embodiment, the second ball member 3420 may include a rotational axis ball 3421 and a plurality of guide balls 3422 spaced apart from the rotational axis ball 3421.

The rotational axis ball 3421 may form the second axis (Y-axis) while rotating in place, in a state in which a position thereof is fixed relative to the carrier 3300 and the housing 1100. The second axis (Y-axis) may pass through the rotational axis ball 3421.

The carrier 3300 and the housing 1100 may include an accommodation groove (3323 and 1123) accommodating the rotational axis ball 3421.

In an embodiment, the carrier 3300 may include a third accommodation groove 3323 accommodating a portion of the rotational axis ball 3421, and the housing 1100 may include a fourth accommodation groove 1123 provided to face the third accommodation groove 3323 and accommodate another portion of the rotational axis ball 3421. For example, the third accommodation groove 3323 and the fourth accommodation groove 1123 may face each other in the direction of the second axis (Y-axis).

The rotational axis ball 3421 may be supported at three points by the third accommodation groove 3323 and the fourth accommodation groove 1123. The third accommodation groove 3323 and the fourth accommodation groove 1123 may include three inclined surfaces to rotate the rotational axis ball 3421 in place.

The plurality of guide balls 3422 may be spaced apart from the second axis (Y-axis), which may be a rotation axis of the carrier 3300, and may support rotation of the carrier 3300 about the second axis (Y-axis).

The plurality of guide balls 3422 may include two ball members (hereinafter, a first guide ball 3422a and a second guide ball 3422b). The first guide ball 3422a and the second guide ball 3422b may be spaced apart in the direction of the first axis (X-axis).

The carrier 3300 and the housing 1100 may include guide grooves 3324, 3325, 1124, and 1125 accommodating the plurality of guide balls 3422. In an embodiment, the carrier 3300 may include a first guide groove 3324 and a second guide groove 3325, spaced apart in the direction of the first axis (X-axis). For example, the first guide groove 3324 may accommodate a portion of the first guide ball 3422a, and the second guide groove 3325 may accommodate a portion of the second guide ball 3422b.

In addition, the housing 1100 may include a third guide groove 1124 and a fourth guide groove 1125, spaced apart in the direction of the first axis (X-axis) to face the first guide groove 3324 and the second guide groove 3325 in the direction of the second axis (Y-axis), respectively. For example, the third guide groove 1124 may be disposed to face the first guide groove 3324, to accommodate another portion of the first guide ball 3422a, and similarly, the fourth guide groove 1125 may be disposed to face the second guide groove 3325, to accommodate another portion of the second guide ball 3422b.

The first guide groove 3324, the second guide groove 3325, the third guide groove 1124, and the fourth guide groove 1125 may extend in the rotational direction of the carrier 3300 as a whole to guide the first guide ball 3422a and the second guide ball 3422b, to move approximately in the rotational direction of the carrier 3300.

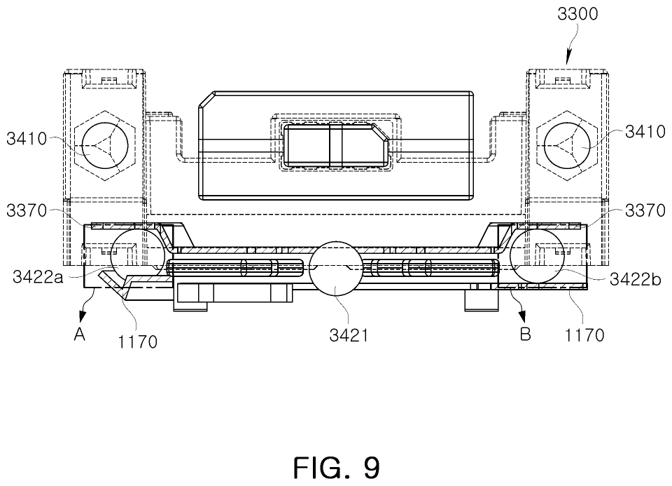

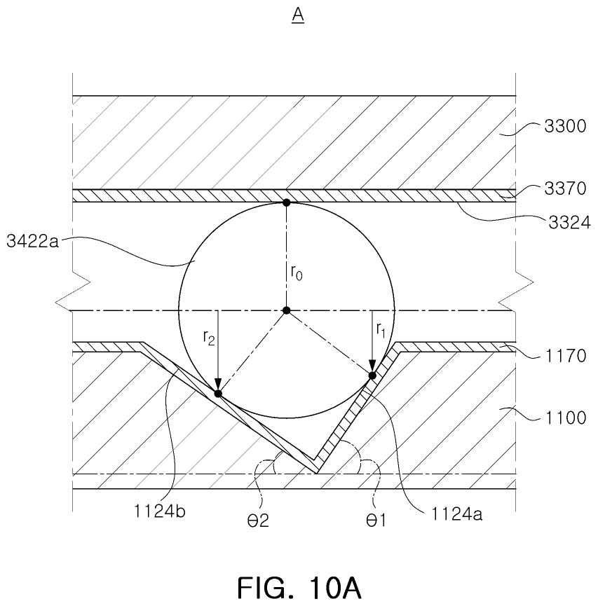

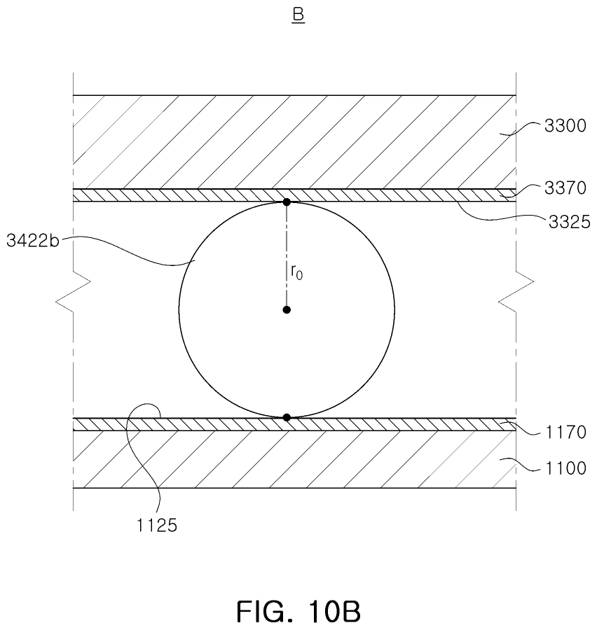

FIG. 9 is a cross-sectional view of FIG. 4, taken along line III-III′. FIG. 10A is an enlarged view of portion A of FIG. 9. FIG. 10B is an enlarged view of portion B of FIG. 9.

Based on the rotational axis ball 3421-or the second axis (Y-axis), the first guide groove 3324 and the third guide groove 1124 may be disposed in one side, and the second guide groove 3325 and the fourth guide groove 1125 may be disposed in the other side.

The first guide groove 3324 and the second guide groove 3325 may extend away from each other, based on the third axis (Z-axis) on the carrier 3300. In addition, the third guide groove 1124 and the fourth guide groove 1125 may extend away from each other, based on the third axis (Z-axis) on the housing 1100.

Referring to FIG. 9, the first guide ball 3422a may be inserted between the first guide groove 3324 and the third guide groove 1124 facing the first guide groove 3324 in the direction of the second axis (Y-axis), and the second guide ball 3422b may be inserted between the second guide groove 3325 and the fourth guide groove 1125 facing the second guide groove 3325 in the direction of the second axis (Y-axis).

According to an embodiment of the present disclosure, the number of contact points formed with the guide grooves 3324 and 1124 by the first guide ball 3422a may be different from the number of contact points formed with the guide grooves 3325 and 1125 by the second guide ball 3422b.

In an embodiment, the first guide ball 3422a may have three contact points with the guide grooves 3324 and 1124, and the second guide ball 3422b may have two contact points with the guide grooves 3325 and 1125.

In an embodiment, the third guide groove 1124 provided in the housing 1100 and accommodating a portion of the first guide ball 3422a may have a different shape from the remaining guide grooves, e.g., the first guide groove 3324, the second guide groove 3325, and the fourth guide groove 1125. For example, the third guide groove 1124 may have a V-shaped cross-section, unlike the remaining guide grooves 3324, 3325, and 1125 having flat cross-sections. For example, the first guide groove 3324 and the third guide groove 1124 may be asymmetrical with respect to the first guide ball 3422a disposed therebetween.

For example, the first guide ball 3422a may be in one-point contact with the first guide groove 3324 and in two-point contact with the third guide groove 1124, thereby having a total of three contact points with the guide grooves 3324 and 1124. The second guide ball 3422b may be in one-point contact with the second guide groove 3325 and the fourth guide groove 1125, thereby having a total of two contact points with the guide grooves 3325 and 1125.

According to an embodiment, the second guide ball 3422b may perform rolling motion with a higher degree of freedom than the first guide ball 3422a. For example, the second guide ball 3422b may freely roll on a plane (X-Z plane), perpendicular to the second axis (Y axis), while being sandwiched between the second guide groove 3325 and the fourth guide groove 1125. A movement direction of the first guide ball 3422a may be restricted by the third guide groove 1124.

Hereinafter, with reference to FIG. 10A, a shape of the third guide groove 1124 according to an embodiment of the present disclosure will be described in detail.

With reference to FIG. 10A, the third guide groove 1124 may have an asymmetrical V-shaped cross-section. The third guide groove 1124 may include a first side surface 1124a and a second side surface 1124b, having different slope angles with respect to a bottom surface of the housing 1100. For example, the first side surface 1124a may be a side surface relatively closer to the second axis (Y-axis)—a center of rotation—than the second side surface 1124b, and the second side surface 1124b may have a gentler slope than the first side surface 1124a.

If the slope angles of the first side surface 1124a and the second side surface 1124b with respect to the bottom surface of the housing 1100 are respectively referred to as a first slope angle θ1 and a second slope angle θ2, the second slope angle θ2 may be smaller than the first slope angle θ1. For example, an angle θi between the first side surface 1124a and the second side surface 1124b may be approximately 90°, and the first slope angle θ1 may be greater than 45°, and the second slope angle θ2 may be smaller than 45°.

The third guide groove 1124 may satisfy the following formula: 45°<θ1≤55°.

In addition, a corner (or intersection) formed by the first side surface 1124a and the second side surface 1124b meeting in the third guide groove 1124 may be biased to one side—toward the first side surface 1124a—from a center of the first guide ball 3422a.

The first guide ball 3422a may have contact points with the first side surface 1124a and the second side surface 1124b, respectively.

In an embodiment, a contact radius (hereinafter, a first contact radius) r1 of the first guide ball 3422a with respect to the first side surface 1124a may be different from a contact radius (hereinafter, a second contact radius) r2 of the first guide ball 3422a with respect to the second side surface 1124b. For example, the second contact radius r2 may be greater than the first contact radius r1.

In this case, when the carrier 3300 rotates about the second axis (Y-axis), a distance (hereinafter, a first distance) by which the first guide ball 3422a rolls about the first side surface 1124a may be different from a distance (hereinafter, a second distance) by which the first guide ball 3422a rolls about the second side surface 1124b. For example, since the second contact radius r2 of the first guide ball 3422a with respect to the second side surface 1124b may be greater than the first contact radius r1 with respect to the first side surface 1124a, the second distance may be greater than the first distance.

According to an embodiment, since the second side surface 1124b may be located relatively farther from a center of rotation than the first side surface 1124a, a greater amount of movement may occur toward the second side surface 1124b when the carrier 3300 rotates. Therefore, as in the present disclosure, the second contact radius r2 of the first guide ball 3422a with respect to the second side surface 1124b should be greater than the first contact radius r1 of the first guide ball 3422a with respect to the first side surface 1124a, to enable stable driving without the occurrence of sliding friction.

Referring further to FIG. 10B, the first guide groove 3324, the second guide groove 3325, and the fourth guide groove 1125 may all have flat cross-sections.

In an embodiment, the first guide groove 3324, the second guide groove 3325, and the fourth guide groove 1125 may be defined by a bottom surface and two side surfaces. For example, the shortest distance between the two side surfaces of the guide grooves 3324, 3325, and 1125 may be greater than a diameter of the first guide ball 3422a and the second guide ball 3422b. Therefore, the first guide ball 3422a and the second guide ball 3422b may have one contact point with the bottom surface in each of the guide grooves 3324, 3325, and 1125. A contact radius of the second guide ball 3422b may be the same as a radius r₀ of the second guide ball 3422b.

In the above, among the two guide grooves 1124 and 1125 provided in the housing 1100, only the third guide groove 1124 may have an asymmetrical V-shaped cross-section, but the fourth guide groove 1125 may also have an asymmetrical V-shaped cross-section, like the third guide groove 1124.

In this case, the first guide ball 3422a and the second guide ball 3422b may have one contact point each in the first guide groove 3324 and the second guide groove 3325 having a flat cross-section provided in the carrier 3300, and two contact points each in the third guide groove 1124 and the fourth guide groove 1125 provided in the housing 1100.

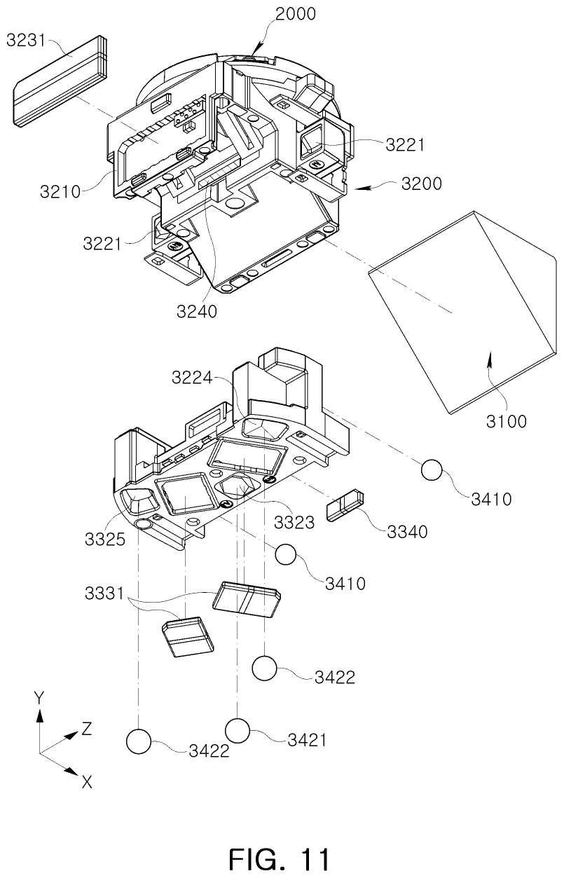

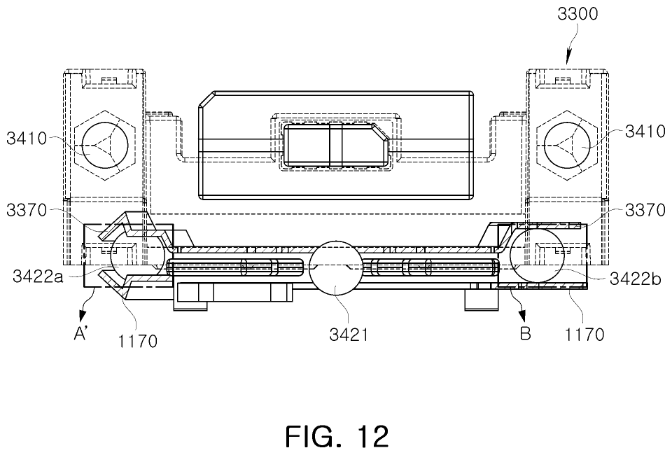

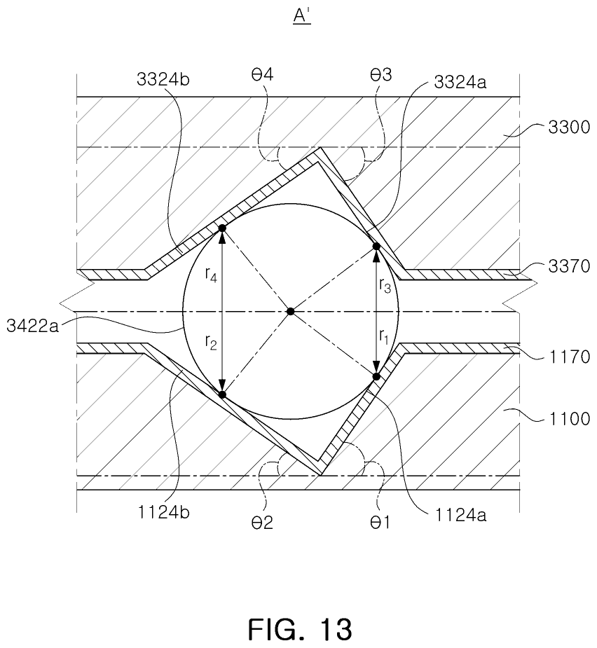

FIG. 11 is a perspective view of a rotary holder according to another embodiment of the present disclosure. FIG. 12 is a cross-sectional view of FIG. 4, taken along line IV-IV′. FIG. 13 is an enlarged view of portion A′ of FIG. 12.

According to another embodiment of the present disclosure, a first guide groove 3324 and a third guide groove 1124, accommodating a first guide ball 3422a, may have a V-shaped cross-section, and a second guide groove 3325 and a fourth guide groove 1125, accommodating a second guide ball 3422b, may have a flat cross-section.

According to the present embodiment, the first guide groove 3324 and the third guide groove 1124 may be symmetrical with respect to the first guide ball 3422a disposed therebetween. However, the first guide groove 3324 and the third guide groove 1124 do not necessarily have to be symmetrical with respect to the first guide ball 3422a.

In an embodiment, the first guide ball 3422a may be in two-point contact with the first guide groove 3324 and the third guide groove 1124, respectively, to have a total of four contact points with the guide grooves 3324 and 1124. The second guide ball 3422b may be in one-point contact with the second guide groove 3325 and the fourth guide groove 1125, respectively, to have a total of two contact points with the guide grooves 3325 and 1125.

Referring to FIG. 13, the first guide groove 3324 and the third guide groove 1124 may have an asymmetrical V-shaped cross-sectional shape. For example, the first guide groove 3324 and the third guide groove 1124 may be symmetrical with respect to the first guide ball 3422a disposed therebetween.

Since the third guide groove 1124 may be the same as the previously described embodiment, description of the third guide groove 1124 will be omitted below.

The first guide groove 3324 may include a third side surface 3324a and a fourth side surface 3324b, having different slope angles with respect to a bottom surface of a carrier 3300. For example, the third side surface 3324a may be a side surface relatively closer to the second axis (Y-axis)—a center of rotation—than the fourth side surface 3324b.

With respect to the first guide groove 3324, the description of the third guide groove 1124 described above may be applied in the same manner.

For example, on the same principle, the fourth side surface 3324b relatively far from the second axis (Y-axis) may have a gentler slope than the third side surface 3324a, and slope angles of the third side surface 3324a and the fourth side surface 3324b with respect to a bottom surface of the carrier 3300 (hereinafter, a third slope angle θ3 and a fourth slope angle θ4, respectively) may also be set in the same manner to a first slope angle θ1 and a second slope angle θ2.

The first guide ball 3422a may have contact points with the third side surface 3324a and the fourth side surface 3324b, respectively. For example, according to the embodiment of FIG. 13, the first guide ball 3422a may have four contact points with the carrier 3300 and a housing 1100.

A contact radius (hereinafter, a third contact radius) r3 of the first guide ball 3422a with respect to the third side surface 3324a may be different from a contact radius (hereinafter, a fourth contact radius) r4 of the first guide ball 3422a with respect to the fourth side surface 3324b, and the fourth contact radius r4 may be greater than the third contact radius r3. In addition, the third contact radius r3 may be approximately equal to a first contact radius r1, and the fourth contact radius r4 may be approximately equal to a second contact radius r2.

Referring to FIG. 9 and the like, portions corresponding to the guide grooves 3324, 3325, 1124, and 1125 of the carrier 3300 and the housing 1100 may include a different material from other portions. For example, a bottom surface and a side surface defining the guide grooves 3324, 3325, 1124, and 1125 may include a metal material (hereinafter, reinforcing portions 3370 and 1170) having higher rigidity than other portions of the carrier 3300 and the housing 1100. The reinforcing portions 3370 and 1170 may be formed integrally with the carrier 3300 and the housing 1100.

According to an embodiment, since the first guide ball 3422a and the second guide ball 3422b roll in a state contacting the reinforcing portions 3370 and 1170 of the metal material, possibility of deformation and damage of the guide grooves 3324, 3325, 1124, and 1125 may be reduced.

The carrier 3300 may be supported on the housing 1100 by magnetic force (magnetic attraction). To this end, a third magnetic body may be disposed on the carrier 3300, and a fourth magnetic body may be disposed on the housing 1100 to face the third magnetic body. For example, the third magnetic body may be a second driving magnet 3331 to be described later, and the fourth magnetic body may be a second yoke 3334 to be described later.

The third magnetic body 3331 and the fourth magnetic body 3334 may generate magnetic attraction in a direction facing each other. In an embodiment, the third magnetic body 3331 and the fourth magnetic body 3334 may face each other in the direction of the second axis (Y-axis), and magnetic attraction therebetween may be generated in the direction of the second axis (Y-axis). Therefore, the carrier 3300 may be supported in the housing 1100 in the direction of the second axis (Y-axis).

A direction in which the carrier 3300 is supported in the housing 1100 may be consistent with a direction in which the carrier 3300 faces the housing 1100 with the second ball member 3420 interposed therebetween. Therefore, the second ball member 3420 may stably support rotation of the carrier 3300 without being separated from the carrier 3300 and the housing 1100 by magnetic attraction generated between the third magnetic body 3331 and the fourth magnetic body 3334.

The reflection module 3000 may include a second driving unit providing a driving force to rotate the carrier 3300.

The second driving unit may include a second driving magnet 3331 and a second driving coil 3332, disposed to face each other. The carrier 3300 may rotate about the second axis (Y-axis) by electromagnetic interaction between the second driving magnet 3331 and the second driving coil 3332.

In an embodiment, the second driving magnet 3331 may be disposed in the carrier 3300, and the second driving coil 3332 may be disposed in the housing 1100. However, a position of the second driving magnet 3331 and a position of the second driving coil 3332 may be swapped, or one thereof may be disposed in the carrier 3300 while the other thereof may be disposed in a different configuration.

The second driving magnet 3331 may be disposed on the bottom surface of the carrier 3300. For example, the second driving magnet 3331 may be disposed between a rotational axis ball 3421 and a plurality of guide balls 3422.

The second driving coil 3332 may be mounted on a main board 6000, and may be disposed in the housing 1100. The second driving coil 3332 may be exposed to an internal space of the housing 1100 through a through-hole formed in the housing 1100, and thus may directly face the second driving magnet 3331.

In an embodiment, the second driving magnet 3331 and the second driving coil 3332 may face each other in a direction, parallel to the second axis (Y-axis).

In an embodiment, the second driving magnet 3331 and the second driving coil 3332 may be provided in plural. For example, the second driving magnet 3331 may include two magnets, and the second driving coil 3332 may include two coils to face the two magnets one-to-one.

The second driving magnet 3331 may be magnetized approximately in the rotational direction of the carrier 3300. For example, one surface of the second driving magnet 3331 facing the second driving coil 3332 may include an N-pole (S-pole) area, a neutral area, and an S-pole (N-pole) area, in the rotational direction of the carrier 3300.

The second driving unit may include a second yoke 3334 facing the second driving magnet 3331 with the second driving coil 3332 interposed therebetween.

The second yoke 3334 may be disposed on the other surface of the main board 6000—a surface opposite to a surface on which the second driving coil 3332 is disposed. The second yoke 3334 may be provided as a magnetic body, and may focus magnetic flux of the second driving magnet 3331.

In addition, the second driving unit may include a second position sensor 3333 detecting a position of the second driving magnet 3331. For example, the second position sensor 3333 may be a Hall sensor, and may detect a change in magnetic flux to detect an amount of movement of the second driving magnet 3331.

The second position sensor 3333 may be disposed to face a neutral area of the second driving magnet 3331 when the carrier 3300 is in a neutral position.

The second position sensor 3333 may be disposed on one surface of the main board 6000 together with the second driving coil 3332, and may be disposed in an inner side or an outer side of the second driving coil 3332.

The reflection module 3000 may include an auxiliary member 3500 preventing collision between the reflection module 3000 and a structure adjacent thereto.

The auxiliary member 3500 may be coupled to both sides of the carrier 3300 to surround a portion of the reflection holder 3200. Therefore, even when an impact occurs, the reflection holder 3200 and the carrier 3300 may be prevented from being separated.

In addition, the auxiliary member 3500 may be provided with a damper, and the damper may absorb impact and noise due to collision by colliding with a counterpart first.

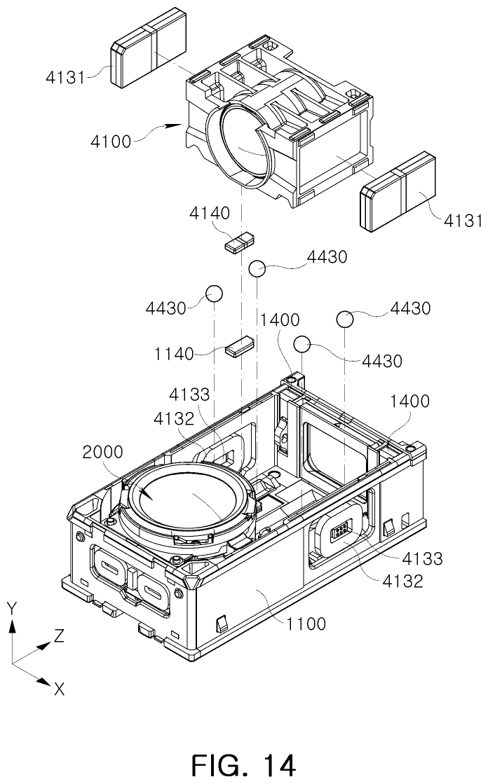

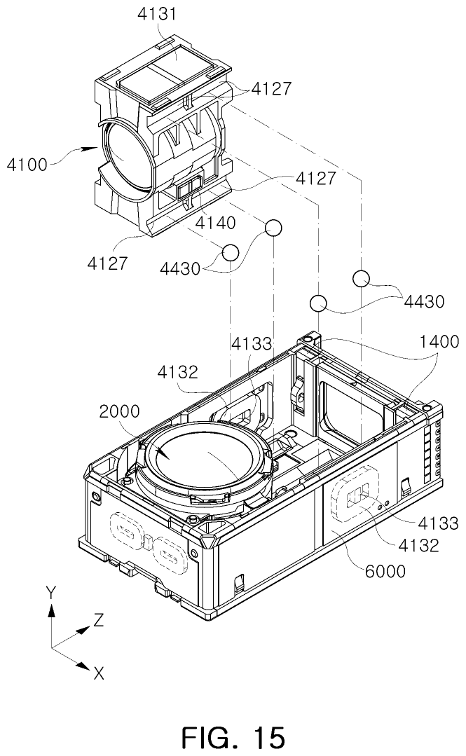

FIG. 14 is an exploded perspective view of a focus adjustment unit according to an embodiment of the present disclosure, and FIG. 15 is an exploded perspective view of a focus adjustment unit, viewed from a different angle than FIG. 14.

Referring to FIG. 14 and FIG. 15, a focus adjustment unit may include a second lens module 4000.

The second lens module 4000 may be spaced apart from the optical image stabilization unit described above in a direction of a second optical axis OA2 in an internal space of a housing 1100.

The second lens module 4000 may include a plurality of lenses disposed in the direction of the second optical axis OA2, and a lens holder 4100 on which the plurality of lenses are mounted. For example, the plurality of lenses may be directly mounted on the lens holder 4100. Alternatively, a second lens barrel (not illustrated) on which a plurality of lenses are mounted may be mounted on the lens holder 4100.

The lens holder 4100 may be movably supported on the housing 1100. In an embodiment, the lens holder 4100 may move in the direction of the third axis (Z-axis) while being supported by the housing 1100. The third axis (Z-axis) may be parallel to the second optical axis OA2, and may be perpendicular to both the first axis (X-axis) and the second axis (Y-axis).

A third ball member 4430 may be disposed between the lens holder 4100 and the housing 1100 to support movement of the lens holder 4100 relative to the housing 1100.

In an embodiment, the third ball member 4430 may include a plurality of ball members supporting one side and the other side of the lens holder 4100—which may be disposed on opposite sides with respect to the third axis (Z-axis). For example, one side and the other side of the lens holder 4100 may be supported by a plurality of ball members disposed spaced apart from each other in the direction of the third axis (Z-axis), respectively. Alternatively, one side of the lens holder 4100 may be supported by a plurality of ball members, and the other side of the lens holder 4100 may be supported by a single ball member.

The lens holder 4100 and the housing 1100 may include guide grooves 4127 and 1127 accommodating the third ball member 4430. Each of the guide grooves 4127 and 1127 may be provided in a number corresponding to the number of third ball members 4430.

In an embodiment, one side and the other side of the lens holder 4100 may be provided spaced apart in the direction of the third axis (Z-axis), and may include a fifth guide groove 4127 accommodating a portion of the third ball member 4430, and the housing 1100 may include a sixth guide groove 1127 facing the fifth guide groove 4127 in the direction of the second axis (Y-axis) and accommodating another portion of the third ball member 4430.

The fifth guide groove 4127 and the sixth guide groove 1127 may be extended in the direction of the third axis (Z-axis). The third ball member 4430 may be inserted between the fifth guide groove 4127 and the sixth guide groove 1127, and may support movement of the lens holder 4100 while moving in the direction of the third axis (Z-axis).

The lens holder 4100 may be supported by the housing 1100 by magnetic force (magnetic attraction). To this end, a fifth magnetic body 4140 may be disposed on the lens holder 4100, and a sixth magnetic body 1140 may be disposed on the housing 1100 to face the fifth magnetic body 4140. For example, one of the fifth magnetic body 4140 or the sixth magnetic body 1140 may be a pulling magnet, and the other thereof may be a pulling yoke.

The fifth magnetic body 4140 and the sixth magnetic body 1140 may generate magnetic attraction in a direction facing each other. In an embodiment, the fifth magnetic body 4140 and the sixth magnetic body 1140 may face each other in the direction of the second axis (Y-axis), and magnetic attraction therebetween may be generated in the direction of the second axis (Y-axis). Therefore, the lens holder 4100 may be supported in the housing 1100 in the direction of the second axis (Y-axis).

A direction in which the lens holder 4100 is supported in the housing 1100 may be consistent with a direction in which the lens holder 4100 faces the housing 1100 with the third ball member 4430 interposed therebetween. Therefore, the third ball member 4430 may stably support movement of the lens holder 4100 without being separated from the lens holder 4100 and the housing 1100 by magnetic attraction generated between the fifth magnetic body 4140 and the sixth magnetic body 1140.

The second lens module 4000 may include a third driving unit providing a driving force for moving the lens holder 4100.

The third driving unit may include a third driving magnet 4131 and a third driving coil 4132, disposed to face each other. The lens holder 4100 may move in the direction of the third axis (Z-axis) by electromagnetic interaction between the third driving magnet 4131 and the third driving coil 4132.

In an embodiment, the third driving magnet 4131 may be disposed in the lens holder 4100, and the third driving coil 4132 may be disposed in the housing 1100. However, a position of the third driving magnet 4131 and a position of the third driving coil 4132 may also be swapped.

The third driving magnet 4131 may be disposed on at least one side surface of the lens holder 4100.

The third driving coil 4132 may be mounted on a main board 6000, and may be disposed in the housing 1100. The third driving coil 4132 may be exposed to an internal space of the housing 1100 through a through-hole formed in the housing 1100, and thus may directly face the third driving magnet 4131.

In an embodiment, the third driving magnet 4131 and the third driving coil 4132 may face each other in a direction, parallel to the first axis (X-axis).

In an embodiment, the third driving magnet 4131 and the third driving coil 4132 may be provided in plural. For example, the third driving magnet 4131 may include two magnets, which may be disposed on both side surfaces of the lens holder 4100. In addition, the second driving coil 4132 may include two coils to face the two magnets one-to-one.

The third driving magnet 4131 may be magnetized in the direction of the third axis (Z-axis)—a moving direction of the lens holder 4100. For example, one surface of the third driving magnet 4131 facing the third driving coil 4132 may include an N-pole (S-pole) area, a neutral area, and an S-pole (N-pole) area, in the direction of the third axis (Z axis).

The third driving unit may include a third yoke 4134 facing the third driving magnet 4131 with the third driving coil 4132 interposed therebetween.

The third yoke 4134 may be disposed on the other surface of the main board 6000—a surface opposite to a surface on which the third driving coil 4132 is disposed. The third yoke 4134 may be provided as a magnetic body, and may focus magnetic flux of the third driving magnet 4131.

In addition, the third driving unit may include a third position sensor 4133 detecting a position of the third driving magnet 4131. For example, the third position sensor 4133 may be a Hall sensor, and may detect a change in magnetic flux to detect an amount of movement of the third driving magnet 4131.

The third position sensor 4133 may be located to face a neutral area of the third driving magnet 4131 when the lens holder 4100 is in a neutral position.

The third position sensor 4133 may be located on one surface of the main board 6000 together with the third driving coil 4132, and may be located in an inner side or an outer side of the third driving coil 4132.

The housing 1100 may be provided with at least one pair of stoppers 1400 facing each other in the direction of the third axis (Z-axis) with the lens holder 4100 interposed therebetween. For example, the stoppers 1400 may be provided in a form fitted into a wall of the housing 1100.

The stopper 1400 may include a damper protruding toward the lens holder 4100. The damper may absorb impact and noise due to collision when the lens holder 4100 collides with the lens holder 4100 first while the lens holder 4100 may move to the maximum in the direction of the third axis (Z-axis) (including +Z and −Z directions). For example, the stopper 1400 may prevent direct collision between the lens holder 4100 and the housing 1100.

According to embodiments of the present disclosure, the driving stability of a reflection module and the optical image stabilization performance of a camera module may be improved.

According to one or more embodiments, the driving stability of a reflection module and a camera module including the same may be improved. The present disclosure aims to provide a reflection module in which positional uncertainty of a ball bearing supporting rotation of the reflection module is eliminated for stable driving, and a camera module including the same.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A reflection module comprising:
a housing having an internal space;
a reflection member disposed in the internal space;
a carrier rotatably disposed with the reflection member in the internal space; and
a plurality of ball members disposed between the housing and the carrier to support rotation of the carrier,
wherein the carrier and the housing comprise a plurality of guide grooves disposed to face each other with the plurality of ball members interposed therebetween,
one or more guide grooves, among the plurality of guide grooves, comprise two side surfaces having different slopes with respect to a plane perpendicular to a rotational axis of the carrier, and
the two side surfaces contact one ball member of the plurality of ball members accommodated in a corresponding one of the one or more guide grooves.

2. The reflection module of claim 1, wherein the plurality of ball members comprise a first guide ball and a second guide ball, each spaced apart from another and from the rotational axis of the carrier, and accommodated in the plurality of guide grooves, and
a number of contact points in which the first guide ball forms with a corresponding one of the plurality of guide grooves is greater than a number of contact points in which the second guide ball forms with a corresponding one of the plurality of guide grooves.

3. The reflection module of claim 2, wherein the carrier comprises a first guide groove accommodating a portion of the first guide ball, and a second guide groove accommodating a portion of the second guide ball,
the housing comprises a third guide groove accommodating another portion of the first guide ball, and a fourth guide groove accommodating another portion of the second guide ball, and
at least the third guide groove, among the first guide groove and the third guide groove, comprises the two side surfaces.

4. The reflection module of claim 3, wherein a second side surface of the two side surfaces is farther from the rotational axis of the carrier than a first side surface of the two side surfaces, and
a slope of the second side surface is less inclined than a slope of the first side surface.

5. The reflection module of claim 4, wherein the first guide groove comprises a third side surface and a fourth side surface farther from the rotational axis of the carrier than the third side surface, and
a slope of the fourth side surface is less inclined than a slope of the third side surface.

6. The reflection module of claim 3, wherein the first guide ball is in contact with the first guide groove at one or two points.

7. The reflection module of claim 3, wherein the second guide ball contacts each of the second guide groove and the fourth guide groove at one point.

8. The reflection module of claim 1, wherein the plurality of guide grooves extends in a rotational direction of the carrier.

9. The reflection module of claim 1, wherein a portion of the one or more guide grooves comprises a reinforcing portion comprising a material having higher rigidity than other portions of the carrier and the housing.

10. The reflection module of claim 2, wherein the plurality of ball members further comprise a rotation axis ball forming the rotation axis of the carrier and spaced apart from the first guide ball and the second guide ball.

11. A camera module comprising:
the reflection module of claim 1;
a first lens module, comprising one or more lenses disposed in a first optical axis direction, coupled to the reflection module; and
a second lens module, comprising a plurality of lenses disposed in a second optical axis direction perpendicular to the first optical axis direction, movably disposed in the second optical axis direction.

12. A reflection module comprising:
a housing having an internal space;
a reflection member disposed in the internal space;
a carrier rotatably disposed with the reflection member in the internal space; and
a first guide ball and a second guide ball, disposed between the housing and the carrier,
wherein each of the carrier and the housing comprises a first guide groove accommodating the first guide ball and a second guide groove accommodating the second guide ball,
the first guide groove in the carrier and the first guide groove in the housing are asymmetrical with respect to the first guide ball, and
the second guide groove in the carrier and the second guide groove in the housing are symmetrical with respect to the second guide ball.

13. The reflection module of claim 12, wherein the first guide groove in the housing comprises two side surfaces having different slopes with respect to a plane perpendicular to a rotational axis of the carrier, and the two side surfaces contact the first guide ball.

14. The reflection module of claim 13, wherein the two side surfaces comprise a first side surface and a second side surface farther from the rotational axis of the carrier than the first side surface, and
a contact radius of the first guide ball with respect to the second side surface is greater than a contact radius of the first guide ball with respect to the first side surface.

15. The reflection module of claim 13, wherein the two side surfaces comprise a first side surface and a second side surface farther from the rotational axis of the carrier than the first side surface, and
a slope of the second side surface is less inclined than a slope of the first side surface.

16. The reflection module of claim 13, wherein the first guide groove in the carrier and the second guide groove in the carrier and the housing comprise a bottom surface having a planar shape, and contacting the first guide ball or the second guide ball.

17. A camera module comprising:
the reflection module of claim 12;
a first lens module, comprising one or more lenses disposed in a first optical axis direction, coupled to the reflection module; and
a second lens module, comprising a plurality of lenses disposed in a second optical axis direction perpendicular to the first optical axis direction, movably disposed in the second optical axis direction.
